(19) United States
(12) Patent Application Publication
(10) Pub. No.: US 2024/0328881 A1
(43) Pub. Date: Oct. 3, 2024

(54) Method For Compensating a Temperature Shock at a Capacitive Pressure Measuring Cell

(71) Applicant: IFM Electronic GmbH, Essen (DE)

(72) Inventors: Manfred Maurus, Bad Waldsee (DE); Peter Kimbel, Tettnang (DE)

(73) Assignee: IFM Electronic GmbH, Essen (DE)

(21) Appl. No.: 18/613,860

(22) Filed: Mar. 22, 2024

(30) Foreign Application Priority Data
Mar. 29, 2023 (DE) 10 2023 107 963.8

(51) Int. Cl. G01L 9/12; G01L 27/00

(52) U.S. Cl. CPC G01L 9/125; G01L 27/007

(57) ABSTRACT

A method for compensating a temperature shock at a capacitive pressure measuring cell is disclosed, the method employs a measuring capacitor and a reference capacitor, wherein in an evaluation unit a pressure measurement value p is obtained by forming the quotient Q from the capacitance values of the reference capacitor and the measuring capacitor and a pressure measurement value p_{M} is obtained by use of the measuring capacitor, wherein the temperature shock is detected by comparing the pressure measurement values p and p_{M} with each other and monitoring the gradient dD of the difference value D of the two values with respect to exceeding a predetermined threshold value. The intensity of the temperature shock is determined based on the gradient dD of the difference value D, whereby the influence of error can be counteracted very quickly and the duration of the influence of error is also very short.

### CROSS REFERENCE TO RELATED PATENT APPLICATIONS

This application claims priority to German Patent Application 10 2023 107 963.8 filed on Mar. 29, 2023 entitled “Verfahren zur Kompensation eines Temperaturschocks an einer kapazitiven Druckmesszelle” (Method For Compensating a Temperature Shock at a Capacitive Pressure Measuring Cell) by Manfred Maurus and Peter Kimbel, the entire disclosure of which is incorporated herein by reference in its entirety.

### BACKGROUND OF THE INVENTION

### 1. Field of the Invention

The invention relates to a method for compensating a temperature shock at a capacitive pressure measuring cell.

### 2. Description of Related Art

Capacitive pressure sensors or pressure measuring devices are used in many industrial sectors for pressure measurement. They often comprise a ceramic pressure measuring cell as a transducer for measuring process pressure and evaluation electronics for signal processing.

Capacitive pressure measuring cells have a ceramic base body and a membrane, wherein a glass solder ring is arranged between the base body and the membrane. The resulting cavity between the base body and the membrane enables the longitudinal movement of the membrane as a result of the influence of pressure. This cavity is therefore also referred to as a measuring chamber. At the underside of the membrane and at the opposite upper side of the base body electrodes are provided, which together form a measuring capacitor. When pressure is applied, the membrane is deformed, which results in a change in the capacitance of the measuring capacitor.

The change in capacitance is detected by use of an evaluation unit and converted into a pressure measurement value. Normally, these pressure sensors are used to monitor or control processes. They are therefore often connected to higher-level control units (PLC).

A capacitive pressure sensor is disclosed, for example, in DE 198 51 506 C1, in which the pressure measurement value is determined from the quotient of two capacitance values of a measuring capacitor and a reference capacitor. Although a pressure measuring cell is not specifically described in this patent specification, the circuit shown and the method described are suitable for capacitive pressure measuring cells. The special feature of this pressure measuring device is that only the amplitude of the square-wave signal is relevant for the evaluation of the measurement signal at the output as a measure of the pressure measurement value, regardless of its frequency.

A circuit arrangement for a capacitive pressure sensor is disclosed in EP 0 569 573 B1, in which, too, a quotient method is used for pressure evaluation.

Quotient methods are generally based on the following pressure dependencies:

$$p ∼ \frac{{C}_{R}}{{C}_{M}}$$

$$or$$

$$p ∼ \frac{{C}_{R}}{{C}_{M}} - 1$$

$$or$$

$$p ∼ \frac{{C}_{M} - {C}_{R}}{{C}_{M} + {C}_{R}} ,$$

wherein C_{M} is the capacitance of the measuring capacitor, C_{R} is the capacitance of the reference capacitor and p is the process pressure to be determined. It is also possible to interchange C_{M} and C_{R} in the quotient. However, the example given with C_{M} in the denominator is the most common form in favor of self-linearization. This form will therefore be assumed in the following, unless otherwise stated.

It is also well known, for example from DE 10 2011 005 705 B4, that the temperature prevailing during pressure measurement, in particular that of the medium to be measured, can have a very significant influence on the accuracy of the measurement results obtained. For this reason, moreover, the temperature is detected in parallel with the pressure measurement by means of a temperature element arranged on the rear side of the base body, so that the temperature dependency of the pressure measurement can be compensated for.

However, a rapid change in temperature, i.e. a so-called thermal shock, poses a challenge, which can lead to tensions in the membrane of the pressure measuring cell. The tensions in the membrane result from a temperature difference between a medium acting on the membrane of the pressure measuring cell and the base body of the pressure measuring cell, which is thermally connected to the environment and faces away from the medium.

Against this background, EP 2 189 774 A1 is based on the realization that a pressure-induced deformation of the membrane differs from a thermal shock-induced membrane deformation in terms of measurement technology. The method disclosed therein for detecting rapid temperature changes is based on the fact that, for measured values of the measuring capacitance Cm, the measured values of the reference capacitance Cr are compared with expected values of the reference capacitance Cr, which follow from the measured values of the measuring capacitance Cm, and wherein a temperature jump is detected if the measured value of the reference capacitance is outside a tolerance range around an expected value. However, this method assumes that a rapid temperature change is the sole cause of the discrepancy found between the measured values and the expected values. However, this is not always the case in practice. For example, in the event of mechanical damage to the pressure measuring cell, in particular the membrane, a comparable effect would occur between the measured and the expected values, which would then lead to the erroneous assumption that it would be necessary to compensate for an acting temperature instead of replacing the pressure measuring cell or ultimately the entire pressure measuring device, because the pressure measurement values output would very likely no longer correspond to the actual pressure conditions.

EP 2 726 833 B1 also discloses a method in which the pairs of values of the two capacitances are monitored within a specified tolerance range in order to determine whether they correspond to the relation of a specified function.

According to EP 3 124 937 B1 a method for temperature compensation is known which is based on the temperature difference between the membrane and the base body of the pressure measuring cell. A temperature sensor is arranged on the membrane and on the base body in order to detect the temperature. The disadvantage here, however, is the enormous delay, which is due to the natural inertia of temperature sensors, which means that the actual compensation process starts only with a delay, too. However, the temperature-related error influence on the measurement result is greatest immediately after the occurrence of a temperature shock, as is known from DE 10 2020 122 128 B3 of the applicant.

It is an object of the invention to start the temperature compensation very early after a temperature shock and thus to significantly reduce the temperature-related measurement error.

### SUMMARY OF THE INVENTION

A method for compensating a temperature shock at a capacitive pressure measuring cell is disclosed, the method comprises a measuring capacitor (C_{M}) and a reference capacitor (C_{R}), wherein in an evaluation unit a pressure measurement value p is obtained by forming the quotient Q from the capacitance values of the reference capacitor (C_{R}) and the measuring capacitor (C_{M}) and a pressure measurement value p_{M} is obtained by use of the measuring capacitor (C_{M}), wherein the temperature shock is detected by comparing the pressure measurement values p and p_{M} with each other and monitoring the gradient dD of the difference value D of the two values with respect to exceeding a predetermined threshold value. The intensity of the temperature shock is determined based on the gradient dD of the difference value D, whereby the influence of error can be counteracted very quickly and the duration of the influence of error is also very short.

### BRIEF DESCRIPTION OF THE DRAWINGS

The present invention is explained by way of example with reference to the attached drawings based on preferred exemplary embodiments, wherein the features shown below both individually and in combination may represent an aspect of the invention. In the drawings:

FIG. 1 is a schematic sectional view of a capacitive pressure measuring cell; and

FIG. 2 is a diagram showing an exemplary course of the temperature-compensated pressure measurement value, the quotient Q, the differential value D, its gradient dD and a differentiated temperature signal over time in the case of a temperature shock without external pressure influence.

In the description of the preferred embodiments that follows, identical reference symbols denote identical or comparable components.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification and the attached drawings and claims.

### DESCRIPTION OF THE PREFERRED EMBODIMENTS

For a general understanding of the present invention, reference is made to the drawings. The present invention will be described by way of example, and not limitation. Modifications, improvements and additions to the invention described herein may be determined after reading this specification and supporting claims and viewing the accompanying drawings; such modifications, improvements, and additions being considered included in the spirit and broad scope of the present invention and its various embodiments described or envisioned herein.

The invention considers the method disclosed in DE 10 2020 122 128 B3 of the applicant, according to which, by comparing the two amounts of the quotient Q and the capacitance value of the measuring capacitor C_{M}, it is switched to a type of “alarm state” at a very early point in time if this comparison deviates from an expected behavior. Specifically, in this comparison, the gradient dD of the differential value D between the pressure measurement value p formed by the quotient and the pressure value p_{M} formed by the measuring capacitor C_{M} is monitored with regard to exceeding a threshold value. Advantageously, the pressure measurement values p and p_{M} have previously been linearized.

According to the invention, in both alternative methods, a plurality of compensation curves have first been stored in a lookup table in an adjustment procedure for various temperature scenarios. The compensation curves were determined empirically and are largely dependent on the design and geometry of the pressure measuring cell. Corresponding tests have shown that the compensation curves are approximately identical across all pressure measuring cells despite different nominal pressure ranges and correspondingly slightly different designs, which makes the process much easier. In both alternative methods, a start time t₀ is also defined as soon as the temperature shock is detected, i.e. the “alarm state” is activated.

In a first alternative of the method according to the invention, the differential value D is continuously recorded after activation of the “alarm state” and the gradient dDₓ is determined therefrom until the maximum gradient dDₘₐₓ is reached. A corresponding temperature scenario is now continuously assigned to the determined gradient dD and a compensation curve associated to the respective temperature scenario is selected from the lookup table.

Alternatively, these process steps can also be implemented in such a way that the differential value D is continuously recorded after activation of the “alarm state” and its maximum gradient dDₘₐₓ is determined by forming the 2nd derivative d²D. A corresponding temperature scenario is then assigned to the determined maximum gradient dDₘₐₓ and the compensation curve associated to this temperature scenario is selected from the lookup table.

Again, both alternatives have in common that the respective compensation value of the selected compensation curve is then added to the pressure measurement value p according to the time elapsed since the start time t₀. This pressure measurement value, now compensated for the temperature influence, is temporarily output instead of the actual pressure measurement value p for further processing. Temporary means, for example, as long as the gradient dD of the difference value D between the pressure measurement values p and p_{M} exceeds the above-mentioned threshold value.

Since the intensity of the temperature shock is determined solely on the basis of the gradient dD of the difference value D, the advantage of the invention is thus that the compensation of the temperature shock is carried out completely without any involvement of a temperature element, since at this early point in time a temperature element cannot yet respond due to its natural inertia. Indeed, the temperature-related error influence on the measurement result is greatest immediately after the occurrence of a temperature shock. In addition, the error influence caused by the temperature shock is extremely small, because the method according to the invention counteracts this very quickly. Moreover, the duration of the influence of error is also so short that the measurement error is already corrected to zero long before the temperature element even responds.

Advantageously, in a further embodiment, the pressure measuring cell comprises a temperature element and the gradient dT of this temperature element is detected and evaluated. This results in the advantageous possibility of carrying out a plausibility check to determine whether a temperature-related error influence, i.e. a temperature shock, is actually present. The absence of a temperature change detected by the temperature element would trigger error handling by generating an error signal, since an error has been detected whose cause is initially unknown.

Another advantageous further embodiment involves switching to a second temperature compensation stage as soon as the differential value D no longer exceeds a predetermined threshold value. In this second compensation stage, the existing gradient dT of the temperature element is then multiplied by a predetermined correction factor, preferably stored in the lookup table, and added to the pressure measurement value p. For further processing, this currently corrected pressure measurement value is then output instead of the previous corrected pressure measurement value.

Advantageously, the temperature compensation is terminated and the original pressure measurement value p formed by the quotient Q is output when the temperature gradient dT falls below a predetermined threshold value.

The invention is explained in more detail below based on exemplary embodiments with reference to the drawings.

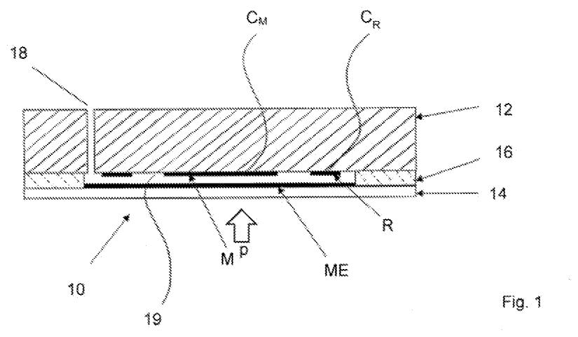

FIG. 1 shows a schematic representation of a typical capacitive pressure measuring cell 10, which is widely used in capacitive pressure measuring devices. The pressure measuring cell 10 essentially has a base body 12 and a membrane 14, which are connected to each other via a glass solder ring 16. The base body 12 and the membrane 14 delimit a cavity 19, which-preferably only at low pressure ranges up to 50 bar—is connected to the rear side of the pressure measuring cell 10 via a venting channel 18.

Both on the base body 12 and on the membrane 14 several electrodes are provided, which form a reference capacitor C_{R} and a measuring capacitor C_{M}. The measuring capacitor C_{M} is formed by the membrane electrode ME and the center electrode M, the reference capacitor C_{R} by the ring electrode R and the membrane electrode ME.

The process pressure p acts on the membrane 14, which bends to a greater or lesser extent depending on the pressure applied, wherein essentially the distance between the membrane electrode ME and the center electrode M changes. This leads to a corresponding change in the capacitance of the measuring capacitor C_{M}. The influence on the reference capacitor C_{R} is smaller, because the distance between the ring electrode R and the membrane electrode ME changes less than the distance between the membrane electrode ME and the center electrode M.

In the following, no distinction is made between the designation of the capacitor and its capacitance value. C_{M} and C_{R} therefore denote both the measuring and reference capacitor itself and their respective capacitance.

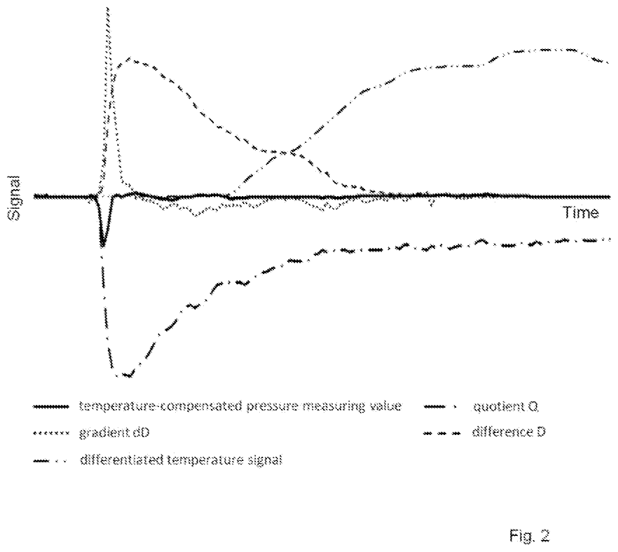

FIG. 2 shows a diagram of what the curves of the temperature-compensated pressure measurement value, the quotient Q, the differential value D, its gradient dD and the differentiated signal of the temperature element over time could look like in the case of a temperature shock without external pressure influence. The quotient Q, which corresponds to the pressure measurement value p and is formed from the capacitance values of the reference capacitor C_{R} and the measuring capacitor C_{M}, is shown as a dash-dotted line, the differential value D between the pressure measurement value p and the pressure measurement value p_{M} obtained only from the measuring capacitor C_{M} is shown as a dashed line and the gradient dD of the differential value D is shown as a dotted line. Furthermore, the differentiated signal of the temperature element is shown as a dashed double dotted line and the temperature-compensated pressure measurement value output for further processing, e.g. to a control device, by use of the method according to the invention is shown as a continuous line.

The temperature shock starts at the point where the signal amplitude of the quotient Q, the difference D and the compensated pressure measurement value deflects step-like downwards or upwards. The significant delay with which the temperature element reacts to the temperature influence can be seen. On the other hand, this strong temperature change is immediately “noticed” in the capacitance values of the measuring and the reference capacitor, wherein the reference capacitor shows a significantly stronger signal deflection compared to the measuring capacitor. This phenomenon is already known from the aforementioned EP 2 189 774 B1 and DE 10 20201 22 128 B3.

Since FIG. 2 is a representation without external pressure influence, the target pressure measurement value, i.e. the quotient Q, should actually be constant on the abscissa, i.e. the zero line. This is clearly not the case and illustrates the enormous influence of the temperature change caused by the shock.

Regarding the signal curves against the background that the abscissa represents the ideal line for a pressure measurement value, moreover, the following is noticeable. On the one hand, when comparing the (uncompensated) quotient Q with the pressure measurement value compensated by the method according to the invention, the significantly lower signal deflection can be seen, as a result of which the measurement error with respect to its amount immediately after the temperature shock is also significantly lower by the method according to the invention. On the other hand, it can be seen that the pressure measurement value compensated by the method according to the invention very quickly returns to the ideal line and thus correctly assumes the value zero, while the uncompensated quotient value is still subject to a measurement error until the end of the diagram.

The method according to the invention is triggered when a predetermined threshold value of the gradient dD of the difference value D between the pressure measurement value p, which is formed by the quotient Q of the capacitance values of the reference capacitor C_{R} and the measuring capacitor C_{M}, and the pressure value p_{M}, which is only obtained from the measuring capacitor C_{M}, is exceeded. If this threshold value is exceeded, an “alarm state” is activated and the compensation method according to the invention is started. Here, it is also advantageous to observe the signal curve of a temperature element, which is advantageously located at the pressure measuring cell 10, more closely in order to see whether the assumed temperature shock is confirmed by a significant increase in the gradient dT of the temperature element. If this is not the case, by means of this plausibility check first an error signal can be generated and another cause of error can be searched.

As soon as the temperature element confirms the temperature shock, it is possible to switch to a second temperature compensation stage. The switchover point would preferably be at the point when the differential value D no longer exceeds a predetermined threshold value. In this second compensation stage, the gradient dT of the temperature element is then used instead of the differential value D based on the capacitances C_{M} and C_{R}. The decision as to whether to switch to this second temperature compensation stage depends on which method is simpler at this point in time or provides the better results. The compensation procedure can be terminated and the pressure measurement value p formed by the quotient Q can be output again if the temperature gradient dT falls below a predetermined threshold value.

### LIST OF REFERENCE SYMBOLS

10 Pressure measuring cell
12 Base body
14 Membrane
16 Glass solder ring
18 Venting channel
19 Cavity
C_{M} Measuring capacitor
C_{R} Reference capacitor
Q Quotient
P Pressure measurement value formed by the quotient Q
p_{M} Pressure measurement value formed by the measuring capacitor C_{M}
D Difference between pressure measurement value p and pressure measurement value p_{M}
M Center electrode
R Ring electrode
ME Membrane electrode

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification and the attached drawings and claims.

What is claimed is:

1. A method for compensating a temperature shock at a capacitive pressure measuring cell (10) which comprises a measuring capacitor (C_{M}) and a reference capacitor (C_{R}), wherein in an evaluation unit a pressure measurement value p is obtained by forming the quotient Q from the capacitance values of the reference capacitor (C_{R}) and the measuring capacitor (C_{M}) and a pressure measurement value p_{M} is obtained by use of the measuring capacitor (C_{M});
wherein the temperature shock is detected by comparing the pressure measurement values p and p_{M} with each other and monitoring the gradient dD of the difference value D of the two values with respect to exceeding a predetermined threshold value;
wherein the method for compensating a temperature shock at a capacitive pressure measuring cell comprises the steps of:
in an adjustment procedure, a plurality of compensation curves has been stored in a lookup table for various temperature scenarios;
defining a start time t₀ as soon as the temperature shock is detected;
continuously detecting the differential value D and determining the gradients dDₓ until the maximum gradient dDₘₐₓ is reached;
continuously assigning a temperature scenario to the determined gradient dD and selecting the compensation curve associated to the respective temperature scenario from the lookup table;
adding the respective compensation value of the selected compensation curve to the pressure measurement value p according to the time elapsed since the start time t₀;
outputting this corrected pressure measurement value for further processing.

2. The method according to claim 1, wherein the pressure measuring cell (10) comprises a temperature element and the gradient dT of the temperature element is detected and evaluated.

3. The method according to claim 2,
wherein a plausibility check is carried out by confirming the temperature shock in the event of a significant increase in the gradient dT of the temperature element and generating an error signal in the event of an unchanged gradient of the temperature element.

4. The method according to claim 2,
wherein a second temperature compensation stage is entered when the differential value D no longer exceeds a predetermined threshold value, wherein the present gradient dT of the temperature element is then multiplied by a stored correction factor and added to the pressure measurement value p and this corrected pressure measurement value is then output for further processing.

5. The method according to claim 3,
wherein a second temperature compensation stage is entered when the differential value D no longer exceeds a predetermined threshold value, wherein the present gradient dT of the temperature element is then multiplied by a stored correction factor and added to the pressure measurement value p and this corrected pressure measurement value is then output for further processing.

6. The method according to claim 2,
wherein the compensation is terminated and the original pressure measurement value p formed by the quotient Q is output when the temperature gradient dT falls below a predetermined threshold value.

7. The method according to claim 3,
wherein the compensation is terminated and the original pressure measurement value p formed by the quotient Q is output when the temperature gradient dT falls below a predetermined threshold value.

8. The method according to claim 4,
wherein the compensation is terminated and the original pressure measurement value p formed by the quotient Q is output when the temperature gradient dT falls below a predetermined threshold value.

9. A method for compensating a temperature shock at a capacitive pressure measuring cell (10) which comprises a measuring capacitor (C_{M}) and a reference capacitor (C_{R}), wherein in an evaluation unit a pressure measurement value p is obtained by forming the quotient Q from the capacitance values of the reference capacitor (C_{R}) and the measuring capacitor (C_{M}) and a pressure measurement value p_{M} is obtained by use of the measuring capacitor (C_{M});
wherein the temperature shock is detected by comparing the pressure measurement values p and p_{M} with each other and monitoring the gradient dD of the difference value D of the two values with respect to exceeding a predetermined threshold value;
wherein the method for compensating a temperature shock at a capacitive pressure measuring cell comprises the steps of:
in an adjustment procedure, a plurality of compensation curves have been stored in a lookup table for various temperature scenarios;
defining a start time t₀ as soon as the temperature shock is detected;
continuously detecting the differential value D and determining the maximum gradient dDₘₐₓ by forming the 2nd derivative d²D;
assigning the temperature scenario associated with the determined maximum gradient dDₘₐₓ and selecting the compensation curve associated with this temperature scenario from the lookup table;
adding the respective compensation value of the selected compensation curve to the pressure measurement value p according to the time elapsed since the start time t₀;
outputting this corrected pressure measurement value for further processing.

10. The method according to claim 9, wherein the pressure measuring cell (10) comprises a temperature element and the gradient dT of the temperature element is detected and evaluated.

11. The method according to claim 10,
wherein a plausibility check is carried out by confirming the temperature shock in the event of a significant increase in the gradient dT of the temperature element and generating an error signal in the event of an unchanged gradient of the temperature element.

12. The method according to claim 10,
wherein a second temperature compensation stage is entered when the differential value D no longer exceeds a predetermined threshold value, wherein the present gradient dT of the temperature element is then multiplied by a stored correction factor and added to the pressure measurement value p and this corrected pressure measurement value is then output for further processing.

13. The method according to claim 11,
wherein a second temperature compensation stage is entered when the differential value D no longer exceeds a predetermined threshold value, wherein the present gradient dT of the temperature element is then multiplied by a stored correction factor and added to the pressure measurement value p and this corrected pressure measurement value is then output for further processing.

14. The method according to claim 10,
wherein the compensation is terminated and the original pressure measurement value p formed by the quotient Q is output when the temperature gradient dT falls below a predetermined threshold value.

15. The method according to claim 11,
wherein the compensation is terminated and the original pressure measurement value p formed by the quotient Q is output when the temperature gradient dT falls below a predetermined threshold value.

16. The method according to claim 12,
wherein the compensation is terminated and the original pressure measurement value p formed by the quotient Q is output when the temperature gradient dT falls below a predetermined threshold value.
